(19) United States
(12) Patent Application Publication
(10) Pub. No.: US 2026/0145637 A1
(43) Pub. Date: May 28, 2026

(54) SYSTEM AND METHOD FOR OPERATING A KEYLESS LOCKING SYSTEM OF A VEHICLE

(71) Applicants: DENSO International America, Inc., Southfield, MI (US); DENDO CORPORATION, Kariya-city (JP)

(72) Inventor: Ryozo FUJII, Novi, MI (US)

(73) Assignees: DENSO International America, Inc., Southfield, MI (US); DENDO CORPORATION, Kariya-city (JP)

(21) Appl. No.: 19/073,437

(22) Filed: Mar. 7, 2025

Related U.S. Application Data
(60) Provisional application No. 63/725,174, filed on Nov. 26, 2024.

(51) Int. Cl. B60R 25/04; B60R 25/104; B60R 25/20; H04W 4/40

(52) U.S. Cl. CPC B60R 25/04; B60R 25/20; H04W 4/40; B60R 25/104

(57) ABSTRACT

A system and method for operating a vehicle function includes a first anchor and a second anchor. A controller is programmed to initiate a scan, determine a scan start time, communicate the scan start time to the first anchor and the second anchor, generate a first scan signal at the controller for a first scanning time period based on the scan start time, generate second scan signal at the first anchor for a second scanning time period offset from the scan start time by a first offset time, generate a third scan signal at the second anchor for third scanning time period offset from the scan start time by a second offset time and form a continuous total scan time period with the first scanning time period, the second scanning time period and the third scanning time period sequentially.

### CROSS-REFERENCE TO RELATED APPLICATION

This application claims the benefit of U.S. Provisional Application No. 63/725,174 filed on Nov. 26, 2024. The entire disclosure of the above application is incorporated herein by reference.

### TECHNICAL FIELD

The present disclosure relates to a keyless locking system for a vehicle,

and, more particularly, to a system and method for controlling devices in the vehicle to receive advertisements from keyless devices.

### BACKGROUND

This section provides background information related to the present disclosure which is not necessarily prior art.

In a keyless entry system, a key fob or mobile phone is used to communicate signals to perform various functions such as locking the vehicle, unlocking the vehicle, starting the engine or generating a warning. The key fob battery life is of concern because advertisements are generated from the fob on a regular basis. When the advertisement is received in the vehicle, a connection is made, and communications are exchanged to perform a function. It is desirable to improve the battery life of the key fob for a vehicle system. One way to increase the battery life is to reduce the rate of advertisement from the key fob. One problem with this approach is that connectivity of the fob with the vehicle may be reduced.

### SUMMARY

This section provides a general summary of the disclosure and is not a comprehensive disclosure of its full scope or all of its features.

The present disclosure provides a system and method for improving the battery life of a fob by adjusting the scheme in which the devices within the vehicle such as an electronic control unit (ECU) and various anchors alternate to scan for the fob. The present system also applies to other electronic key devices such as those in a cellular phone. The system also accommodates both a key fob and an electronic key device.

In one aspect of the disclosure, a system for operating a vehicle function includes a first anchor and a second anchor. A controller is programmed to initiate a scan, determine a scan start time, communicate the scan start time to the first anchor and the second anchor, generate a first scan signal at the controller for a first scanning time period based on the scan start time, generate second scan signal at the first anchor for a second scanning time period offset from the scan start time by a first offset time, generate a third scan signal at the second anchor for third scanning time period offset from the scan start time by a second offset time and form a continuous total scan time period with the first scanning time period, the second scanning time period and the third scanning time period sequentially.

In another aspect of the disclosure, a method of controlling a vehicle function includes initiating a scan, determining a scan start time, communicating the scan start time to at least some of a plurality of scanning devices, generating a first scan signal at a first scanning device of the plurality of scanning devices for a first scanning time period based on the scan start time, generating a second scan signal at a second scanning device of the plurality of scanning devices for a second scanning time period offset from the scan start time by a first offset time, generating a third scan signal at a second scanning device of the plurality of scanning devices for a third scanning time period offset from the scan start time by a second offset time and forming a continuous total scan time period with the first scanning time period, the second scanning time period and the third scanning time period sequentially.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a diagrammatic view of a vehicle relative to a key fob and an electronic device as part of the system.

FIG. 2A is a prior art illustration of a high frequency key fob communicating with an ECU.

FIG. 2B is a low frequency key fob communicating with an ECU.

FIG. 3A is a time chart illustrating a high frequency key fob generating advertisements that are to be received.

FIG. 3B is a time chart with a lower frequency showing a connection made.

FIG. 3C is a plot of a method for operating the timing for the various devices in the system to form a total scan period as set forth.

FIG. 4 is time plot where each scan period aligns with a different portion of the overall scanning time period.

FIG. 5 is a timing chart showing the scan timing relative to an advertise signal.

FIG. 6 is a time plot illustrating the timing when an electronic key device is provided.

FIG. 7 illustrates the communications when either a key fob or a smart phone are used.

Corresponding reference numerals indicate corresponding parts throughout the several views of the drawings.

### DETAILED DESCRIPTION

Example embodiments will now be described more fully with reference to the accompanying drawings.

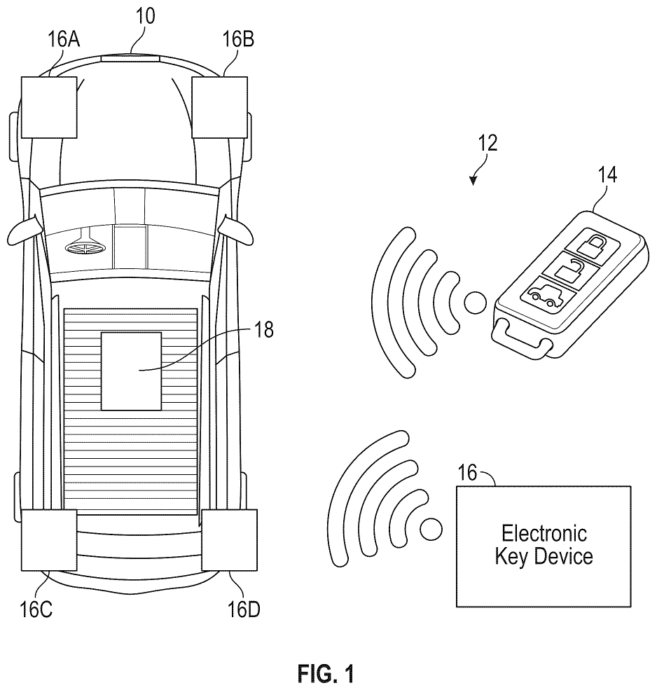

Referring now to FIG. 1, a high level diagrammatic view of a vehicle 10 that is part of a system 12 is set forth. The system 12 includes a key fob 14 and an optionally electronic key device 16. The electronic key device 16 may be referred to as a car connectivity consortium (CCC) digital key or digital key device when the CCC standards are used. The electronic key device 16 and the key fob 14 are used to communicate advertisement signals to the vehicle 10. Advertisement signals are signals that essentially let other devices know that a fob is present, and the fob would like to for a communication connection. In particular, the fob 14 and the electronic key device 16 are used to communicate advertisements to a plurality of anchors such as four anchors 16A, 16B, 16C and 16D, in this example. Of course, other locations and numbers of anchors 16A-D may be provided such as at the door handles, the tailgate or other locations. The vehicle 10 also includes an electronic control unit (ECU) 18 that may be referred to as a controller 18. The anchors, 16A-D and the ECU may each be referred to as a scanning device that may scan in any order.

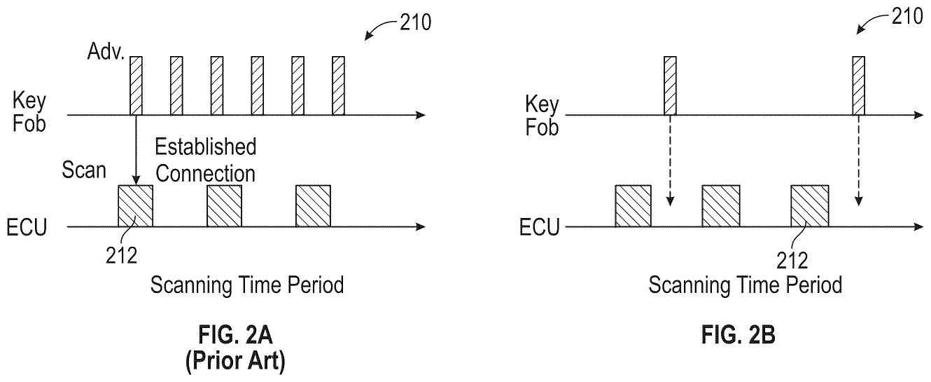

Referring now to FIG. 2A, a timing chart showing the key advertisements 210 from a key fob or electronic key device of the prior art is set forth. The advertisements 210 are at a relatively high frequency. A first scan signal having scanning time periods 212 are illustrated that eventually allow the key and the electronic controller 18 of FIG. 1 to establish a connection.

In FIG. 2B, the ECU scanning time periods 212 are the same as in FIG. 2A. However, the key fob frequency is lower with the advertisements spaced further apart. Therefore FIG. 2B shows that a connection between the ECU and the key fob cannot be established.

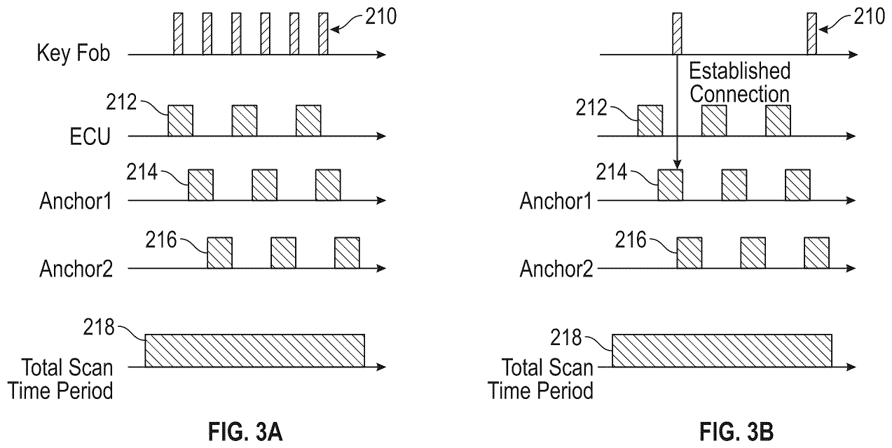

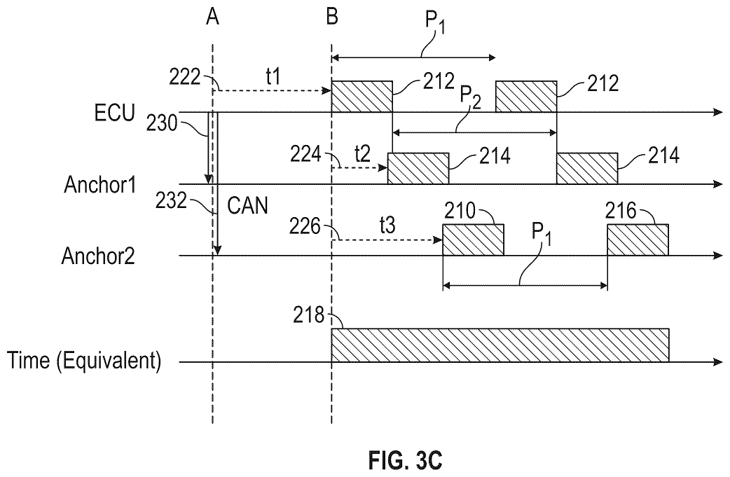

Referring now to FIG. 3A, each of the ECUs and anchors are illustrated having scan signals with scanning time periods 212, 214 and 216. The scanning time periods 212, 214 and 216, when added together, form a total scan time period 218. The continuous total scan time period 218, as can be seen on the figure, is continuous from the time the ECU, the first anchor and the second anchor perform their scanning time periods, the key fob has high frequency in FIG. 3A.

Referring now to FIG. 3B, the key fob 14 or the electronic key device 16, as illustrated in FIG. 1, has a lower frequency than that of FIG. 3A. Therefore, the scanning time periods 212, 214 and 216 are used sequentially and eventually receive the advertisement signals 210. This allows connectivity to be maintained and to be improved by effectively continuously scanning from the vehicle and allows a connection to take place when the advertisement frequency is low.

Referring now to FIG. 3C, plots of scanning time periods 212 by the ECU are illustrated relative to the scanning time periods 214 and 216 of Anchor 1 and Anchor 2. The total scanning time period is illustrated at 218. In this example, a waiting time 222 is communicated to each of the anchors by the controller or ECU. In addition, an offset time or simply, offset 224, labeled as t2, is communicated to Anchor 1. Another offset time 226 may be communicated to the second anchor, Anchor 2, and is labeled as t3. A time between the beginning of a scanning time period (illustrated at B) to the beginning of the next scanning time period of the same device is referred to as time period P₁. The period P₁ is the same for each of the devices. The difference in each row is that offset times are provided so that ultimately, a continuous total scan time 218 is achieved to scan for advertisements. Details of this will be described in greater detail below. It should be noted that the offset times t2 and t3 may be stored in a memory of the anchors or the ECU in advance. Each device needs to know the respective offset and the scan start time so that total scanning time period 218 is achieved.

The communication signals 230, 232 for communicating the waiting time t1 are illustrated. The signals 230, 232 are communicated through a controller area network within the vehicle 10. The period P1 and the length of each scanning time period 212, 214 and 216 may be communicated in the communication signals 230, 232. However, some data may be communicated during manufacturing because of the fixed nature of the values.

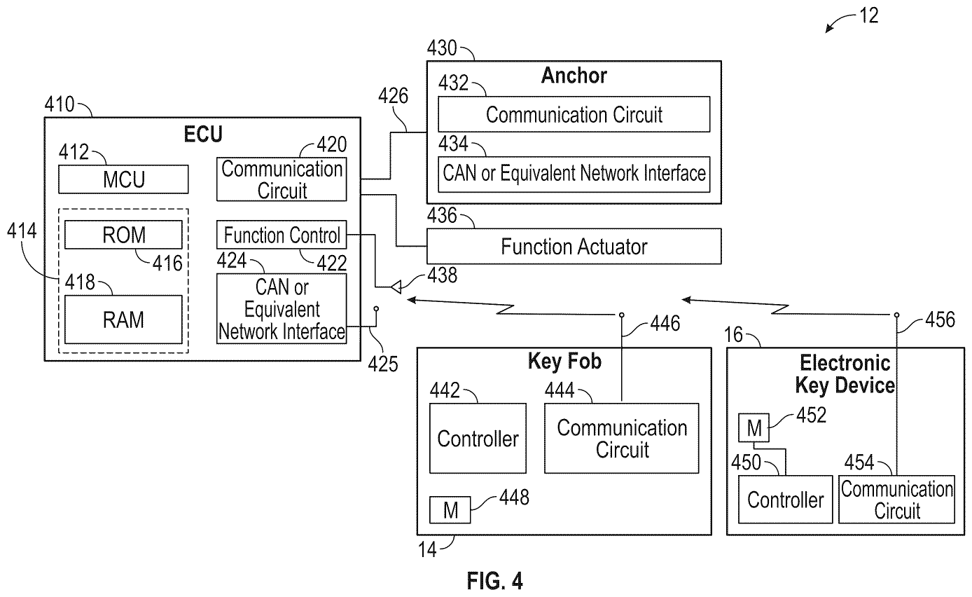

Referring now to FIG. 4, a block diagrammatic view of the system 12 is illustrated. An ECU may be referred to as a controller 410 is illustrated. The controller 410 has a microcontroller unit 412 that may be referred to as a processor. The processor 412 is in communication with a memory 414. The memory 414 has a read only memory 416 and a random access memory 418. The memories 414, 416 may be a non-transitory computer-readable medium including machine-readable instructions that are executable by the processor 412. The instructions include steps for operating the processor and performing one of the methods as will be described in greater detail below. In other words, the microcontroller unit is programmed to perform various functions including communicating with the various devices and allowing a handover between an anchor device so that the controller 410 can communicate with a fob or electronic key device. The memory 414 may store various time periods such as the offset t1, the scanning time period 212 and the period P1. In addition, the scanning time periods 214 and 216 may be stored. The period time and the scanning time periods may be communicated through the network 426 to the anchors 430.

The controller 410 includes a communication circuit 420. The communication circuit 420 may be used to communicate (send and receive) in a Bluetooth® format or an ultra-wide band (UWB) format. Of course, the communication circuit 410 may be used to communicate with both formats. Other formats may be used by the communication circuit 410 for communicating with the various devices such as the anchors 430 of the system 12.

The controller 18 may be in communication with a function controller 422. The function controller 422 may control actuators of the vehicle to control vehicle functions such as lock, unlock, sound an alarm, start an engine or other types of actions. The function controller 422 may control actuators using a network interface 424. The interface 424 communicates through a controller area network (CAN) 426 to various devices such as the anchors (Anchor 1, Anchors 2 mentioned above). In this example, a single anchor 430 is representing any number of anchors is illustrated. The anchor 430 may include a communication circuit 432 that is used for communicating through the controller area network 426. The communication circuit 432 communicates through the network interface 434. A function actuator 436 of the vehicle 10 is illustrated. The function actuator 436 may control vehicle functions such as a lock actuator for unlocking or locking a door, an alarm for generating an audible, visual or a combination of both warning signal to those nearby the vehicle. A speaker device 438 may be used to generate an audible warning signal from the function controller 422. The audible warning signal may be used to call attention to an unsettling condition.

A key fob device 440 has a controller 442 that is in communication with a communication circuit 444. The communication circuit 444 may communicate with the controller 442 which enables the communication circuit 444 to generate advertising signals and communicate them wirelessly through an antenna 446. The communication circuit 444 may communicate wirelessly to the controller 410 and, in particular, through the antenna 425 of the controller 410. The controller 442 may have a memory 448 that is used for storing the offsets, the period and the waiting time period illustrated in FIG. 3C. The controller 442 may also be programmed to communicate advertisements at the frequency illustrated in FIG. 3C.

The electronic key device 16 is illustrated in further detail. The electronic key device 16 includes a controller 450 that is communication with a memory 452. The memory 452 may act in a similar manner to the memory 448 of the key fob 14. That is, the memory 452 may store the waiting time and the frequency through which the electronic key device communicates. A communication circuit 454 communicates with the controller 410 wirelessly through an antenna 456. A different frequency and wavelength may be used by the electronic key device from that used by the key fob 14.

As will be described in greater below, many anchors 430 may be provided within a vehicle. The anchors 430 may be dedicated to either communicating in Bluetooth low energy format or UWB format. The anchors 430 may therefore be different in that they may receive signals from one of the key fob 14 or the electronic key devices 16.

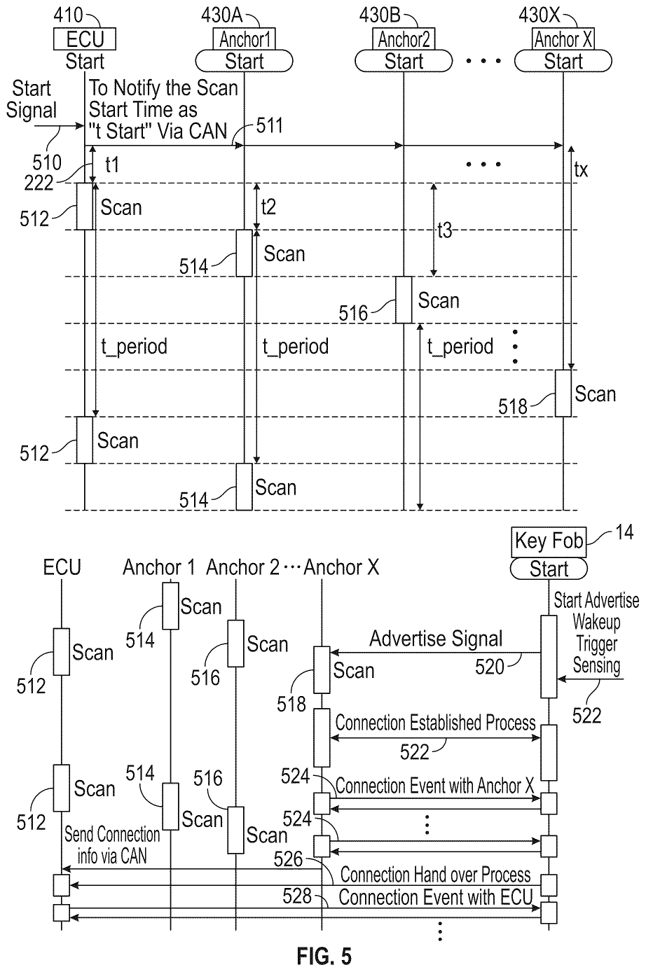

Referring now to FIG. 5, the system starts the process by receiving a start signal 510. The start signal 510 may one of a plurality of types of signals for initiating the scanning for advertisement process. For example, the start signal 510 may be a trigger from a power on signal, a wake up signal, a return on signal from a deep sleep or the like. The start signal 510 is communicated to the ECU or controller 410. In this example, an anchor 430A, an anchor 430B and an anchor 430X as illustrated as a plurality of anchors. As mentioned above, various numbers of anchors may be used together with the ECU 410 to scan for advertisements. The wait time t1 is illustrated. The wait time t1 may be communicated to each of the other anchors 430A-430X. The waiting time 222 is the time that each of the devices use in addition to other offsets to generate the first scanning time periods. In this example, the ECU 410 has no offset. A scan period t_period is established from the beginning of the scan period 512. The first scan period 512 has a duration and takes a total of the total scan period t_period when the “off” time is considered. The off time is the time until the next scanning time period. Relative to Anchor 1 at 430A, an offset t2 in addition to the waiting time t1 is waited until the beginning of a scan period 214 is performed to look for advertisements. The period t_period is the same for all of the anchors and the ECU and includes the scan period and the off time.

Anchor 2 begins transmitting at the delay time t1 plus an offset t_3. Anchor 2 430B has the scan time 516. The anchor 430X has the scan time 518. When all of the scans are added together, the total scan time period t_period is established. No advertisements will be missed in this manner.

At the bottom of the time chart of FIG. 5, the scan period 218 of AnchorX receives an advertisement signal 520 from the key fob 14. The key fob 14 may be triggered by a trigger signal 522 that may be a motion sensing signal. The motion signal of signal 522 may be generated based upon a user approaching the vehicle and being within the communication range of the antenna 425. The advertisement signal 520 is received during the scan period and therefore a connection is established with the connection signal 522. The anchor 430X establishes a connection with the key fob 14 and ultimately a connection event happens at step 524 and may be a handshake process. The connection event may have various connection signals exchanged therethrough. Ultimately, the key fob 14 generates a connection handover at step 526. A handover signal is communicated from the key fob to the ECU or controller 410. Ultimately, a connection event is established at 528 so that a communication signal may be exchanged between the key fob and the ECU 410.

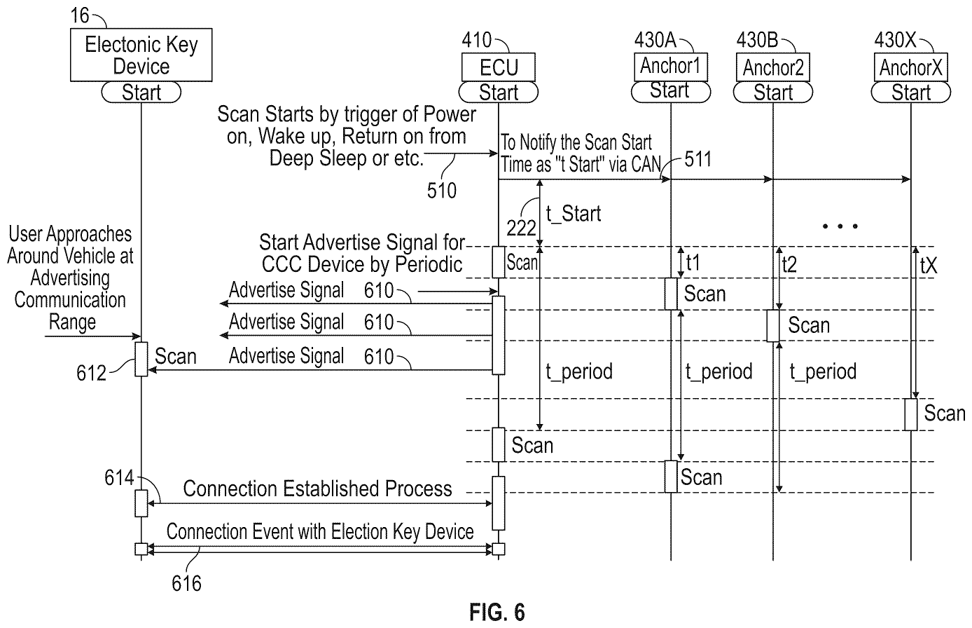

Referring now to FIG. 6, a similar process to that illustrated above is set forth with the addition of the electronic key device 16. In this example, the electronic key device 16 replaces the key fob 14 illustrated in FIG. 5. In this example, the start signal 510 initiates the process as in FIG. 5. The scan start time is determined at the controller and is communicated as signal 511 to the various anchors 530A-530X. The waiting time t_start at 222 is communicated through the signal 511. As mentioned above, the offsets t1, t2 and tx may also be communicated through the signal 511. However, the offsets t1, t2 and tx may be pre-programmed into the memory of the electronic key device for the key fob. In this example, the advertised signals 610 are communicated at various times from the ECU 410. The advertised signals may be received during a scan period 612 of the electronic key device. Therefore, a connection is established. The connection established process 614 may communicate various signals between the electronic key device 16 and the ECU 410. A connection event with the electronic key device is illustrated by the signals 616 that are two way and in between the electronic key device and the ECU 410. Once a connection is established, the communication may take place. In this example, should a connection be established by one of the anchors, the process for handing over communication to the controller 410 is the same as that illustrated at the bottom of FIG. 5 above and is therefore not repeated.

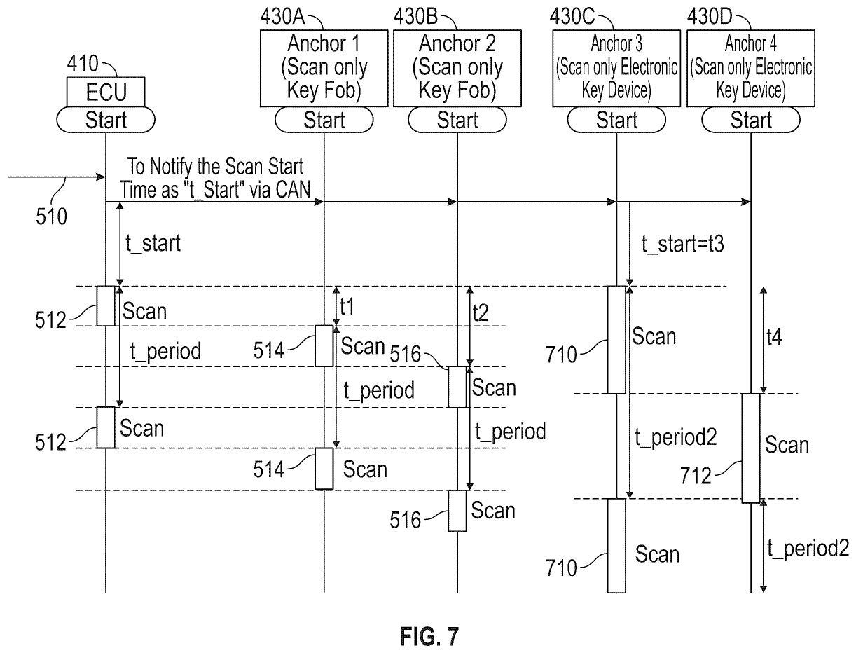

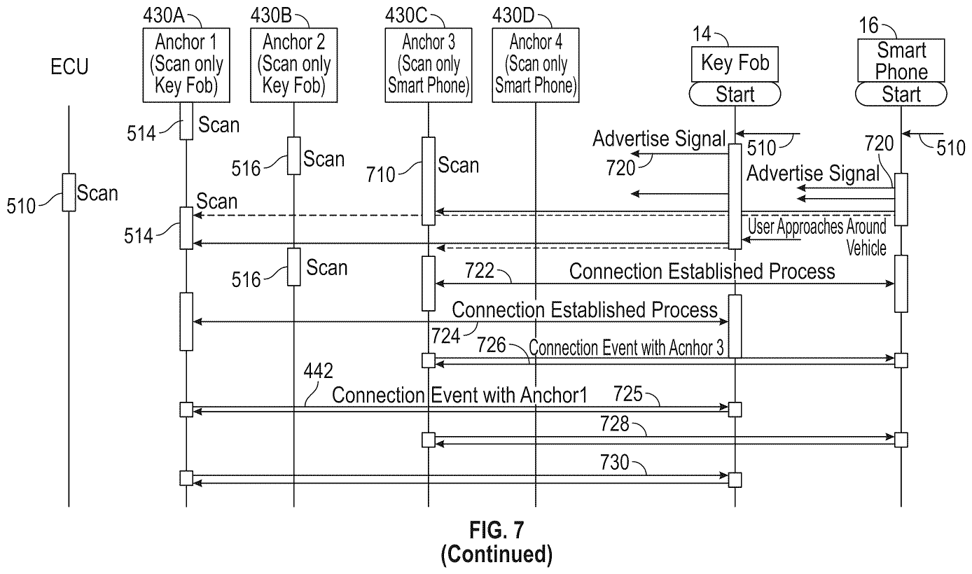

Referring now to FIG. 7, another example of a method for operating the system is set forth. In this example, the anchors are dedicated to communicating with either the key fob 14 or the electronic key device 16. In this example, anchors 430A and 430B are used to communicate with the key fob 14 illustrated in FIG. 4. Anchors 430C and 430D are used to communicate only with the electronic key device. The system starts in a similar manner to that illustrated above with respect to FIG. 5 in that a start signal 510 is generated from some external system within the vehicle. The ECU 410, in response to the start signal, communicates a scan start time by communicating a waiting time to each of the anchors 430A-430D. In this example, the offsets t1 and t2 may also be communicated or prestored in the anchors 430A, 430B, respectively. In this example, the electronic key device may be treated slightly different in that the waiting signal may be used to wait for trying to communicate with the electronic key device. The waiting signal t_start may be common with the original waiting time. A fourth time period t_4 may be used in addition to the t_start period. In this example, two periods, t_period, is from the beginning of the first scan period to the next scan period for the ECU device and the anchor devices. For the anchors 430C and 430D, a second total scan period, t_period2, is set forth. The scan time periods 710 and 712 may be greater than the scan periods used by the key fob dedicated anchors 430A and 430B.

By allowing specific anchors to ignore different types of signals from different types of devices, other communications may take place. In this example, the smart signals are generated by an off device or on device motion detection or the like. Advertising signals 720 are generated by the key fob 14 and are broadcasted. Likewise, the smart phones or other electronic key device 16 receive a start advertising signal by one of the devices within the device. In this example, the key fob 14 communicates with at least one of the anchor devices. In this example, the anchor device 430C receives an advertising signal from the smartphone 16. The key fob signal is received by the first anchor device 430A. The anchor device 430C communicates a connection established signal by the established process 722. Likewise, the key fob may also perform a connection establish process 724. Ultimately, a connection may be placed between the third anchor 430C and a smart phone 16 a connection event signal 726. The key fob 14 then may be used to generate a connection event at the first anchor. As illustrated, the connection event signal 726 allows a communication with external systems. A connection event is therefore provided between the key fob 14 and the first anchor which only communicates with the key fob. Various signals are exchanged at reference numeral 442. The key fob 14 may also start a communication during the process with Anchor1.

A sequence of steps is represented by reference numeral 728 and 730 in which at step 718, communication between a smart phone and the third anchor 430C is provided. Likewise, the key fob 14 established a connection with the first anchor 430A.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A system comprising:
a first anchor;
a second anchor; and
a controller programmed to initiate a scan;
determine a scan start time;
communicate the scan start time to the first anchor and the second anchor;
generate a first scan signal at the controller for a first scanning time period based on the scan start time;
generate second scan signal at the first anchor for a second scanning time period offset from the scan start time by a first offset time;
generate a third scan signal at the second anchor for third scanning time period offset from the scan start time by a second offset time; and
form a continuous total scan time period with the first scanning time period, the second scanning time period and the third scanning time period sequentially.

2. The system of claim 1 wherein the controller is programmed to determine the scan start time and communicate the scan start time to the first anchor and the second anchor from the controller through a controller area network.

3. The system of claim 2 wherein the controller, the first anchor or the second anchor receive an advertisement from a device.

4. The system of claim 1 wherein the first anchor or the second anchor receive an advertisement from a fob or electronic key device wherein the first anchor or the second anchor are programmed to form a connection with the device.

5. The system of claim 4 wherein the first anchor or the second anchor are programmed to hand over control to the controller, said controller programmed to perform a vehicle function through a function controller.

6. The system of claim 1 wherein the first anchor and the second anchor are configured to communicate in a first format, further comprising a digital key device, a third anchor configured to communicate with the digital key device in a second format and a fourth anchor configured to communicate with the digital key device in a second format, the controller configured to communicate in the first format and the second format.

7. A method of controlling a vehicle function comprising:
initiating a scan;
determining a scan start time;
communicating the scan start time to at least some of a plurality of scanning devices;
generating a first scan signal at a first scanning device of the plurality of scanning devices for a first scanning time period based on the scan start time;
generating a second scan signal at a second scanning device of the plurality of scanning devices for a second scanning time period offset from the scan start time by a first offset time;
generating a third scan signal at a second scanning device of the plurality of scanning devices for a third scanning time period offset from the scan start time by a second offset time; and
forming a continuous total scan time period with the first scanning time period, the second scanning time period and the third scanning time period sequentially.

8. The method of claim 7 wherein initiating a scan comprises initiating a scan in response to a trigger received a controller.

9. The method of claim 7 wherein determining the scan start time comprises determining the scan start time at a controller.

10. The method of claim 9 wherein communicating the scan start time to a first anchor and a second anchor of the plurality of scanning devices from the controller.

11. The method of claim 10 wherein communicating the scan start time to the first anchor and the second anchor from the first controller through a controller area network.

12. The method of claim 10 wherein after forming, receiving an advertisement signal from a device at the controller, the first anchor or the second anchor.

13. The method of claim 12 wherein receiving the advertisement comprises receiving the advertisement in a first format, wherein the first anchor and the second anchor are configured to communicated in a first format.

14. The method of claim 13 further comprising receiving the advertisement in a second format at a third anchor, a fourth anchor or the controller, wherein the third anchor and the fourth anchor are configured to communicated in the second format.

15. The method of claim 10 wherein after forming, receiving an advertisement signal from a device at the first anchor or the second anchor.

16. The method of claim 15 further comprising establishing a connection with the first anchor or the second anchor.

17. The method of claim 16 further comprising handing over control to the controller.

18. The method of claim 17 further comprising performing a vehicle function through a function controller of the controller.

19. The method of claim 17 wherein performing a function comprises at least one of unlocking the vehicle, locking the vehicle, starting the vehicle or generating an audible warning signal.

20. The method of claim 10 wherein the controller, the first anchor and the second anchor communicate using the same period, wherein the first anchor and the second anchor are offset from the start time by the first offset time and the second offset time.
